(19) United States
(12) Patent Application Publication
(10) Pub. No.: US 2011/0012380 A1
(43) Pub. Date: Jan. 20, 2011

(54) MOTOR VEHICLE DOOR LOCK

(75) Inventors: Thorsten Bendel, Oberhausen (DE); Claus Topfer, Sindelfingen (DE); Winfried Schlabs, Bochum (DE)

Correspondence Address: Konomi Takeshita, Eight Penn Center, Suite 1300,, 1628 John F. Kennedy Blvd., Philadelphia, PA, 19103, US

(73) Assignee: KIEKERT AKTIENGESELLSCHAFT, Heiligenhaus (DE)

(21) Appl. No.: 12/867,746

(22) PCT Filed: Feb. 6, 2009
(86) PCT No.: PCT/DE09/00168

§ 371 Date: Sep. 29, 2010

(30) Foreign Application Priority Data
Feb. 15, 2008 (DE) 10 2008 009 506.0

(51) Int. Cl. E05B 15/02

(52) U.S. Cl. 292/341.16

(57) ABSTRACT

A motor vehicle door lock comprising a locking mechanism (1, 2) and a closing/opening device (3 to 7) including a drive (3, 4, 5), acting upon the locking mechanism (1, 2), wherein the drive (3, 4, 5) is configured as a linear drive (3, 4, 5).

### FIELD OF THE INVENTION

The invention relates to a motor vehicle door lock comprising a locking mechanism and a closing/opening device including a drive acting on the locking mechanism.

### BACKGROUND OF THE INVENTION

A variety of such motor vehicle door locks are known from practical applications and literature. In this context we refer to EP 1 319 780 A1, providing motorized closing of a door or tailgate with the aid of a conventional electric motor. This means that the locking mechanism, after reaching a certain operating position—in most cases the intermediate closed position—is moved into its end position or the fully closed position. This is a comfortable arrangement as an operator only has to move the respective door or tailgate into the intermediate closed position, with the closing element completing the full closing process.

In addition, there are also so-called assisted opening means available, ensuring that the locking mechanism is opened by a motor. One example for such assisted opening means is described in DE 10 2004 052 599 A1. These means are first and foremost also used for reasons of offering a higher level of comfort.

The known closing/opening devices are, in parts, based on a complicated lever arrangement, producing the required torques. This often results in considerable travel of the drives or compact electrical motors, often used at this point. As the entire closing/opening device is, for instance, located inside a vehicle door, a tailgate or similar, noise created by the closing/opening operation is often directly transmitted to the passenger compartment as a result of a structure-borne noise transmission. This is increasingly regarded as unacceptable. The invention aims to provide a solution for this problem.

### SUMMARY OF THE INVENTION

The invention is based on the technical problem of developing such a motor vehicle door lock further so that the overall noise level of, in particular, the closing/opening device is reduced.

In order to solve this technical problem the invention suggests that in a motor vehicle door lock of the described type, the drive for the closing/opening device is designed as a linear drive. Advantageously said linear drive comprises a motor and a linear actuator.

The motor is usually a small or compact low-weight electric motor. The motor either directly or indirectly operates the linear actuator on which it acts, which in turn—again directly or indirectly—acts upon a closing pawl or a comparable closing/opening element. The closing pawl can engage in the profile of the locking mechanism, generally a profile of the catch.

According to the invention, the closing/opening device thus comprises at least a motor or an electric motor, a linear actuator acted upon by the electric motor constituting an overall linear drive as well as a closing/opening element that is generally a closing pawl. As according to the invention, the drive is designed as a linear drive, it offers compact dimensions, a low weight and produces little or hardly any operating noise. This means that in contrast to state-of-the-art solutions, the drive of the closing/opening device of the invention produces minimal noise.

This is mainly due to the fact that such linear drives or, in particular, linear actuators, are generally designed in such a way that they contain a spindle and an associated spindle element moved to and fro on the spindle. The spindle can be a threaded spindle, with the spindle element being preferably a spindle nut. By turning the spindle or threaded spindle or spindle nut, the spindle element or the spindle nut can be moved up and down the spindle, producing the desired linear movement. Due to the exact engagement of the threads of the spindle in the internal thread of the spindle nut and the low speed, this operation is practically silent.

The linear actuator or its spindle and spindle element can be made of various materials such as steel or plastic or of course also combinations thereof with a plastic spindle element moving to and fro on a steel spindle. The motor and respective electric motor produces the required rotary movement.

It is recommended to use a gear reduction with the motor or electric motor, running quickly in most cases. In this way, not only the speed of the spindle compared to the speed of an output shaft of the motor is reduced but, at the same time, also the torque is increased on the output side of the linear actuator. This is necessary to ensure that in spite of the small dimensions and compact design, the motor can apply the force on the locking mechanism required for closing or opening it.

To produce the described gear reduction or torque conversion, the linear drive normally contains a gear mechanism arranged between the motor and the linear actuator. The gear mechanism is, in particular, a worm gear mechanism. Such a worm gear mechanism generally comprises an endless screw engaging in a worm gear, with the aid of which the spindle and spindle nut is driven. This design allows the linear actuator and motor to be arranged at an angle to each other with the positioning to each other being rectangular in most cases. The drive of the spindle or spindle nut can also be produced via other gear mechanisms, such as bevel gears, belt drive.

The linear drive can consequently be relatively flexibly arranged in or on the motor vehicle door lock to adapt to the prevailing topological circumstances. In principle, this also includes the option of designing the linear drive as a separate module independent from the lock casing of the motor vehicle door lock, usually accommodating the locking mechanism. The transmission of the movement provided by the linear drive can, in this case, be guaranteed by a transmission element, acting upon the locking mechanism or the closing/opening element assigned to the locking mechanism. This aspect provides further flexibility as regards attachment, in particular as the linear drive can be positioned in or on a chassis component due to the low noise generated.

The linear movement of the spindle element of the linear actuator or generally of the linear drive is usually transmitted onto the closing/opening element on the locking mechanism side with the aid of a lever arrangement. In this way, another increase or conversion in torque can be produced. The said lever arrangement can also easily convert the linear movement produced by the linear drive into a mostly curved actuating movement for the closing/opening element.

Alternatively, the linear movement of the linear drive can also be transmitted onto the closing/opening element via a Bowden cable.

It has also proven to be advantageous to provide the linear drive with at least one position sensor. In most cases, two position sensors are provided, detecting the respective end positions of the linear drive or in the detail of the spindle element and transmitting these to a control unit. Based on the signals of the one or several position sensors, the control unit can then stop the motor for the linear actuator or reverse its direction of rotation.—In the linear drive, a clutch between the motor and the gear mechanism ensures that the drive shaft of the motor acts on the linear actuator with torsional flexibility.

Although linear drives are already being used for motor vehicle door locks, this is only in connection with the locking or unlocking of the locking mechanism (see DE 195 01 493 B4, DE 103 44 244 A1 and DE 699 01 229 T2). This is because of the fact that in the past, the travel of such linear drives was regarded as too small and the design effort required for such closing/opening devices as too great and the noise problem was not recognized. The invention has overcome all of these preconceptions. It provides a linear drive with a travel from several millimeters to centimeters, convinces by its low weight of, in most cases, considerably less than 200 g and allows the transmission of sufficient torque, in particular for the closing process. This is all possible without unwanted operating or actuating noise. The invention thus provides considerable advantages.

### BRIEF DESCRIPTION OF THE DRAWINGS

Below, the invention is explained in more detail with reference to exemplary drawings showing only one embodiment, as follows:

FIG. 1 shows a section of the motor vehicle door lock of the invention, in this case mainly the linear drive;

FIG. 2 shows the linear drive including the closing/opening device as well as a locking mechanism in a first view;

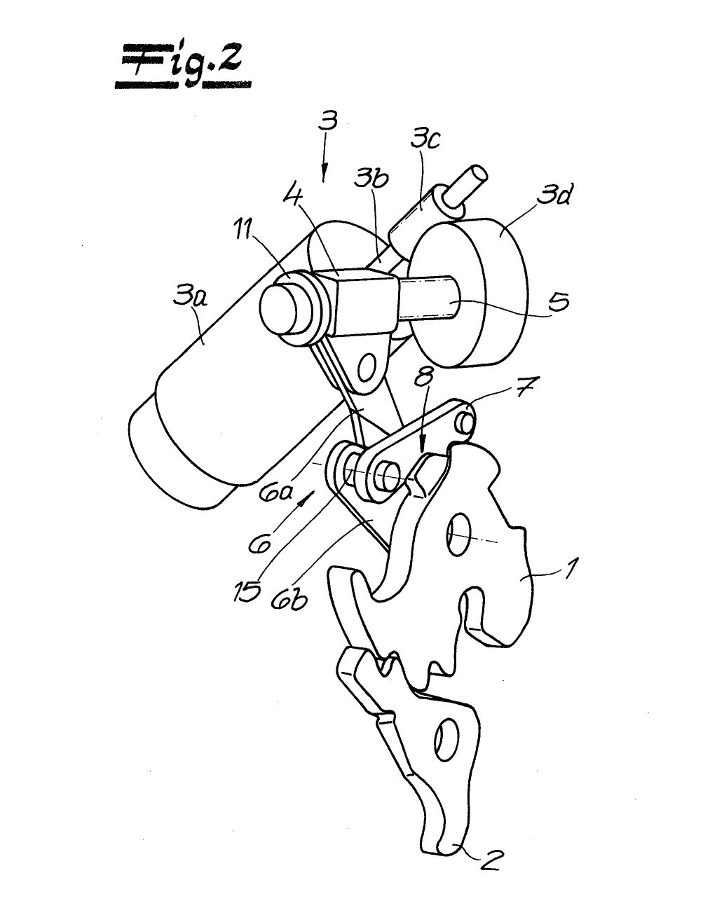

FIG. 3 shows a rear view of the object of FIG. 2; and

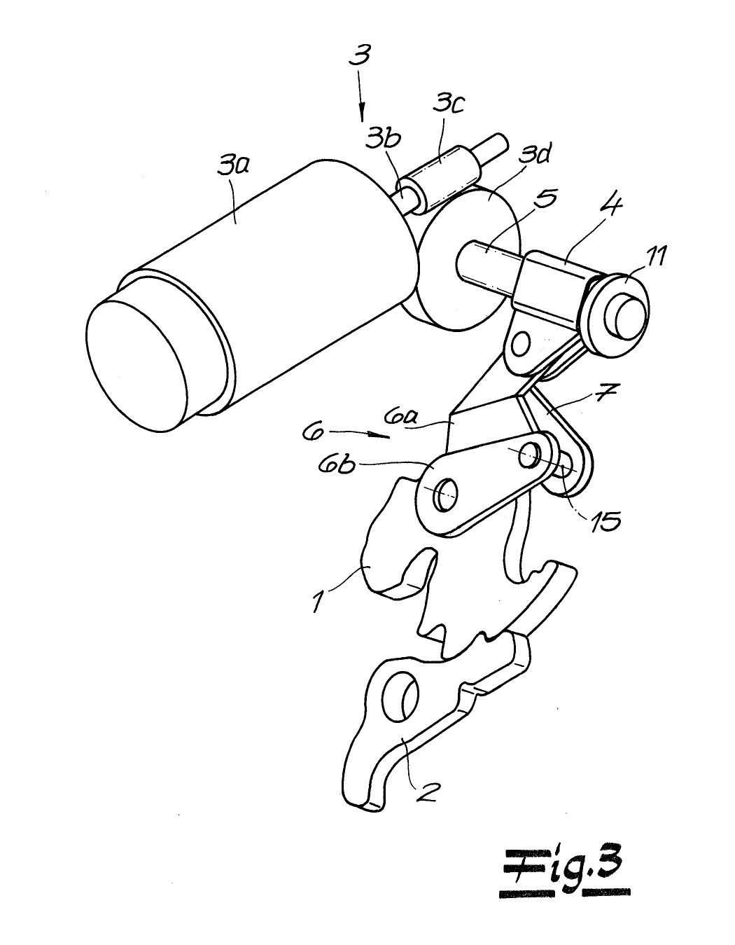

FIG. 4 shows the object of FIGS. 1 to 3 once installed.

Other features and advantages of the present invention will become apparent from the following detailed description, taken in conjunction with the accompanying drawings which illustrate, by way of example, the principles of the invention.

### DETAILED DESCRIPTION OF THE INVENTION

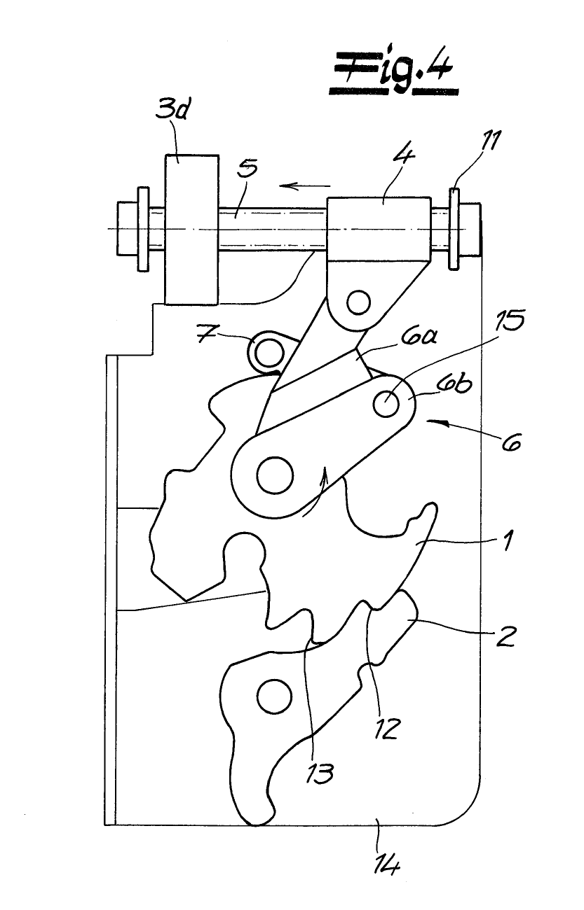

FIG. 4 shows a motor vehicle door lock comprising, as usual a locking mechanism 1, 2 consisting of a catch 1 and a respective pawl 2. A closing/opening device 3 to 7 is assigned to the locking mechanism 1, 2 and is in this case designed as an assisted closing element 3 to 7, acting upon the locking mechanism 1, 2 to close it.

For this purpose, the closing/opening device or assisted closing element 3 to 7 contains a drive 3, 4, 5 designed as a linear drive 3, 4, 5 in the embodiment. The linear drive mainly 3, 4, 5 mainly consists of a motor 3a with a drive shaft 3b, acting upon a linear actuator 4, 5. Although the invention is not limited to this, the linear drive 3, 4, 5 of the embodiment contains an intermediate gear mechanism 3c, 3d between the motor 3a and the linear actuator 4, 5 which is designed as a worm gear 3c, 3d in the embodiment. The motor 3a including drive shaft 3b as well as the gear mechanism 3c, 3d together form a motor drive 3, rotationally acting upon the linear actuator 4, 5.

The linear actuator 4, 5 in turn comprises a spindle 5 and a spindle element 4 with the spindle 5 in the embodiment being linearly moveable to and fro and thus producing a stroke movement. The spindle 5 is, in this case, a threaded spindle 5, with the spindle element 4 being a spindle nut 4.

As a whole, the linear drive 3, 4, 5 acts directly or indirectly on a closing/opening element 7, which in the embodiment is designed as a closing pawl 7, engaging in a profile 8 of the locking mechanism 1, 2. In the embodiment, the profile 8 is formed on the outside of the catch 1 so that the closing pawl 7 interacts with said profile on the catch 1.

The basic design also includes a lever arrangement 6 with the aid of which the linear drive 3, 4, 5 acts upon the closing/opening element or the closing pawl 7. Consequently the closing/opening device or assisted closing element 3 to 7 comprises the linear drive 3, 4, 5, the lever 6 and finally the closing pawl 7. The linear drive 3, 4, 5 in turn includes the motor drive 3 and the linear actuator 4, 5.

The lever arrangement 6 of the embodiment contains two levers 6a, 6b. Lever 6a is designed as a spindle lever 6a and is rotationally connected to the spindle element or the spindle nut 4. In the embodiment, the other lever 6b is, on the other hand, designed as a pawl lever and is, on one hand, arranged on a common axis with the catch 1 and, on the other hand, rotationally connected to the closing/opening element or the closing pawl 7.

In an embodiment—not shown—the operative connection between the linear drive 3, 4, 5 and the closing pawl 7 can also be a Bowden cable.

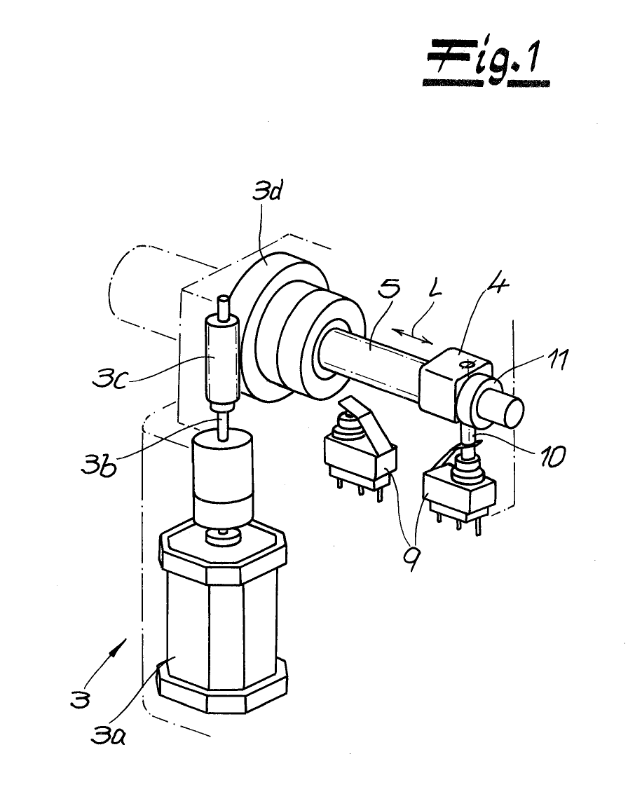

Finally, FIG. 1 shows two position sensors 9, activated at the spindle nut 4 by means of a feeler pin 10 which can thus stop the motor 3a via a, for instance, a control unit—not shown—or can reverse its direction. This is possible as the motor or electric motor 3a is a compact electric motor 3a, running in both directions of rotation. The apparent outer bearing buffers 11 ensure that the spindle 5 or the spindle element or the spindle nut 4 can only be moved to and fro in linear direction L within the travel determined by the outer bearing buffers 11.

The device operates as follows. In order to move catch 1 from the so-called intermediate closed position shown in FIG. 4 together with a pawl 2 engaged in an intermediate closed position 12 to a fully closed position in which the pawl 2 engages into a fully closed position 13 at the catch 1, it is necessary that the closing pawl 7 engaging in the profile 8 of the catch 1 turns the catch 1 in the example counter-clockwise as indicated by the directional arrow in FIG. 4. The invention achieves this by moving the spindle element or the spindle nut 4 to the left in the view shown in FIG. 4. This is achieved by the motor or electric motor 3a rotating the spindle or threaded spindle 5. For this purpose, the drive shaft 3b of the motor 3a contains a worm 3c, meshing with a worm gear 3d of the worm gear drive 3c, 3d. The worm gear 3d has a common axis with the spindle 5 to which it is connected in a rotationally fixed manner.

The rotations of the worm gear 3d consequently directly cause the spindle 5 to rotate. This causes the spindle element or the spindle nut 4 to move in linear direction L or, depending on the electric motor 3a, to rotate to the left, as depicted in FIG. 4, so that, as a consequence, catch 1 carries out the desired counter-clockwise movement. During the left movement of the spindle nut 4, the spindle lever 6a of the lever mechanism 6 follows this movement, causing the pawl lever 6b to rotate counter-clockwise as one of its ends is practically fixed to a lock casing 14 on a common axis with the catch 1, whilst the other end is moved to the left together with the spindle lever 6a and the spindle nut 4. As the closing pawl 7 is moveably connected to this other end or to the pawl lever 6b at a common rotational point 15, the closing pawl 7 carries out the desired counter-clockwise movement, following the catch 1, as the closing pawl 7 engages with the profile 8 on the catch 1.

The drawing shows that the linear actuator 4, 5 and the motor 3a are arranged at an angle to each other with both the motor 3a and the linear actuator 4, 5 being connected to the lock casing 14 or linked with it in the embodiment. It is basically also possible to arrange the linear drive 3, 4, 5 completely separately from the lock casing 14 and to define a separate module for it. The connection between the linear drive 3, 4, 5 and the locking mechanism 1, 2 or the at this point unchanged lever mechanism 6 can be provided by a transmission element which, advantageously, is a Bowden cable or similar. This Bowden cable can engage with the spindle lever 6a instead of the spindle nut 4. This is not shown in the figures.

It is to be understood that the above-described embodiment is illustrative of one of the many possible specific embodiments which can represent applications of the principles of the invention. Numerous and varied other arrangements can be readily devised by those skilled in the art without departing from the spirit and scope of the invention.

1. A motor vehicle door lock comprising:
a locking mechanism (1, 2) and a closing/opening device (3 to 7) including a drive (3, 4, 5), acting upon the locking mechanism (1, 2) wherein the drive (3, 4, 5) is a linear drive (3, 4, 5).

2. The motor vehicle door lock according to claim 1, wherein the linear drive (3, 4, 5) comprises at least a motor (3a) and a linear actuator (4, 5).

3. The motor vehicle door lock according to claim 2, wherein the linear drive (3, 4, 5) and the motor (3a) are arranged at an angle and, in particular, at right angles to each other.

4. The motor vehicle door lock according to claim 1, wherein the linear drive (3, 4, 5) contains a clutch (16).

5. The motor vehicle door lock according to claim 1, wherein the linear drive (3, 4, 5) contains a spindle (5) and a spindle element (4).

6. The motor vehicle door lock according to claim 1, wherein the linear drive (3, 4, 5) comprises at least a motor (3a) and a linear actuator (4, 5) and contains an intermediate gear mechanism (3c, 3d) and in particular a worm gear (3c, 3d) between the motor (3a) and the linear actuator (4, 5).

7. The motor vehicle door lock according to claim 1, wherein the linear drive (3, 4, 5) acts directly or indirectly on a closing/opening element (7), engaging into a profile (8) of the locking mechanism (1, 2).

8. The motor vehicle door lock according to claim 1, wherein the linear drive (3, 4, 5) contains a lever arrangement (6) on a locking mechanism side.

9. The motor vehicle door lock according to claim 1, wherein the linear drive (3, 4, 5) contains at least one position sensor (9).

10. The motor vehicle door lock according to claim 1, wherein the linear drive (3, 4, 5) acts upon the locking mechanism (1, 2) by means of a transmission element.
